(19) United States
(12) Patent Application Publication
(10) Pub. No.: US 2008/0080750 A1
(43) Pub. Date: Apr. 3, 2008

(54) Interactive wireless fingerprint recognition system

(75) Inventors: Chap-Meng Bee, Jhunan Township (TW); Jer-Chuan Huang, Yijhu Township (TW)

Correspondence Address: TROXELL LAW OFFICE PLLC, SUITE 1404, 5205 LEESBURG PIKE, FALLS CHURCH, VA, 22041, US

(73) Assignee: WISON TECHNOLOGY CORP.

(21) Appl. No.: 11/540,976

(22) Filed: Oct. 2, 2006

(51) Int. Cl. G06K 9/00

(52) U.S. Cl. 382/124

(57) ABSTRACT

An interactive wireless fingerprint recognition system utilizes fingerprint recognition to promote the convenience of use and the security of wireless controlling an external target at a remote site. A piezoelectric switch unit is utilized to trigger a wireless transmission device for capturing and characterizing the fingerprint image of the user. Next, the fingerprint image is packed into a data packet with a data packet format compatible with a Self-described Protocol with Variable Length (SPVL). The data packet is transmitted to a wireless reception device by the wireless transmission unit. After being decoded, the data are compared with the embedded fingerprint data of the user. Next, a control signal is sent out from an external target interface unit to make the back-end external target to execute the required functional operation, and the execution result is also sent back actively or passively to the wireless transmission device immediately or a periodically.

### FIELD OF THE INVENTION

The present invention relates to an interactive wireless fingerprint recognition system, and more particularly to a system that transmits user's fingerprint data by wireless transmission and recognizes the user's identity by fingerprint recognition so as to promote system's security and convenience of wireless remote control.

### BACKGROUND OF THE INVENTION

With the progress of technology and civilization, people rely on diverse electronic products and enjoy the convenience brought about by them progressively. These electronic products, such as car-use remote controllers, entrance guard remote controllers, TV remote controllers, and so forth, provide the public with significantly promoted convenience of life. However, these conventional remote controlling devices only provide a simplex function for controlling the electronic products at remote sites. They do not take into further consideration the security of data transmission, the functionality, and the recognition of user's identity. But, there are increasingly imperious demands to provide the public with these functions.

FIG. 1 illustrates the framework of a conventional remote control system, which has a hand-held remote control emitter A, wherein the emitter A has a function key A1 for input of various functional operations. The inputted data are encoded and encrypted by an encoder A2, and the encrypted data are transmitted to a wireless module B1 of a remote control reception device B at a remote site by a wireless module A3. The received data are decrypted by a decoder B2, and transformed into a control signal by the wireless module B1 for controlling a back-end external target C so as to, for example, actuating the vehicle engine. This conventional wireless remote control system only has a simplex function, and it is unable to recognize the user's identity or ensure the system's security. Besides, it is only suitable for one-way operation and cannot provide with interactive two-way communication. Moreover, in regard to the aspect of power control, this conventional system utilizes the sleeping mode to achieve the function of saving power.

In order to ensure the system's security, the user's identity is usually confirmed through a key or a card carried by the user or a personal recognition code or password for providing the function of remote operation. However, it is very inconvenient to carry the key or card, which has the problem of loss while the inputted personal recognition code or password may be cracked easily or forgotten frequently. Accordingly, the aforesaid methods cannot promote the security of system and fulfill the requirement for convenience of use effectively.

### SUMMARY OF THE INVENTION

It is a main object of the present invention to provide an interactive wireless fingerprint recognition system that utilizes fingerprint recognition to promote system's security and convenience of wireless remote control for avoiding the problem caused by the adoption of password, which is cracked and forgotten easily.

It is another object of the present invention to provide an interactive wireless fingerprint recognition system that utilizes fingerprint recognition to recognize the user's identity to protect the wireless remote control device from being misappropriated.

It is a further object of the present invention to provide an interactive wireless fingerprint recognition system that utilizes a Self-described Protocol with Variable Length (SPVL) for data transmission so as to provide the flexible, multi-functional application.

It is a still further object of the present invention to provide an interactive wireless fingerprint recognition system that utilizes interactive two-way communication to ensure the accuracy of the execution result of the wireless remote control device and to obtain the real-time status feedback of the device.

It is a still further object of the present invention to provide an interactive wireless fingerprint recognition system that utilizes a piezoelectric switch to fulfill the requirement for saving more power and energy.

In order to achieve the above-mentioned object, an interactive wireless fingerprint recognition system is comprised of a wireless transmission device, a wireless reception device and an external target.

The wireless transmission device comprises: a piezoelectric switch unit to supply the wireless transmission device with the electric power when pressed down by the finger or to cut off the power supply when released from the finger so that it is more power-saving than the sleeping mode; a fingerprint capture unit for capturing the user's fingerprint image; a fingerprint image processing and control unit for receiving the fingerprint image captured by the fingerprint capture unit, transforming the fingerprint image into a fingerprint minutia by a fingerprint type processing algorithm that embeds therein, encrypting this original template, packing it into a data packet with a packet format that is compatible with a Self-described Protocol with Variable Length (SPVL), and delivering the data packet; and a wireless transmission unit for receiving the data packet delivered from the fingerprint image processing and control unit and for transmitting the data packet to a remote site via various transmission frequencies or technologies.

The wireless reception device comprises: a wireless transmission unit for receiving the data packet transmitted from the wireless transmission device and delivering it to a fingerprint template processing and control unit. The fingerprint template processing and control unit receives and decodes the data packet to compare the decoded original template with an enrolled fingerprint template by a fingerprint matching algorithm and to deliver this matching result to an external target interface unit. The external target interface unit transforms the matching result into a control signal to control the operation of a back-end external target, such as vehicle actuation or unlocking, entrance guard system control, TV actuation, or transaction verification, and so forth. In addition, the accuracy of the real-time execution result of a wireless remote control device and the real-time status feedback of the device can be obtained. As a result, the function of recognizing the user's identity can be provided so as to provide the system with promoted security and convenience of use.

After characterizing the fingerprint image, the fingerprint image is packed into a packet with a packet format defined by a Self-described Protocol with Variable Length (SPVL) before transmission. By the use of the data descriptor of the SPVL protocol that has the properties of self-description and variable length, the information of the fingerprint template can be recombined without transmitting the data packet in sequence so that the flexible, multi-functional application can be achieved.

The aforementioned objects and advantages of the present invention will be readily clarified in the description of the preferred embodiments and the enclosed drawings of the present invention.

### BRIEF DESCRIPTION OF THE DRAWINGS

FIG. 1 is a control flow diagram of a conventional remote control system.

FIG. 2 is a flow diagram of the system of the present invention.

FIG. 3 is schematic diagram showing a fingerprint image captured by a fingerprint capture unit of the present invention.

FIG. 4 is schematic diagram showing a fingerprint template obtained after a fingerprint image processing and control unit extracts the template of the fingerprint image of the present invention.

FIG. 5 is a flow diagram showing the fingerprint template extraction of the present invention.

FIG. 6 is a schematic diagram showing the packet format defined by SPVL protocol of the present invention.

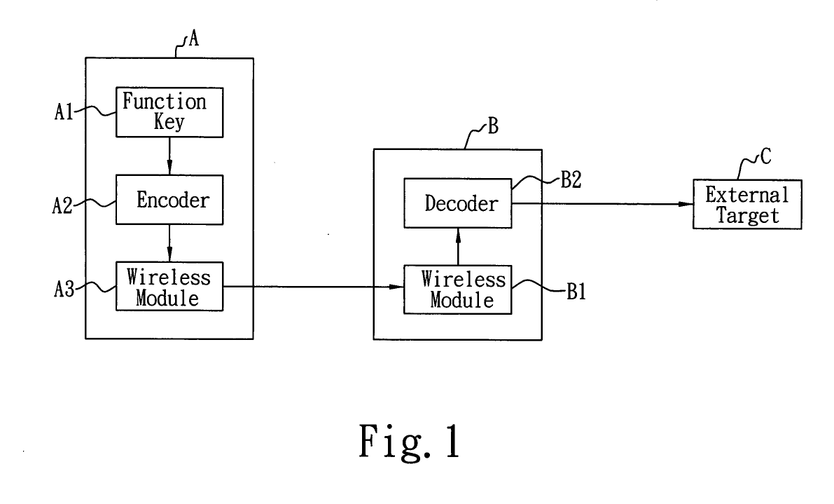

### DETAILED DESCRIPTION OF THE PREFERRED EMBODIMENT

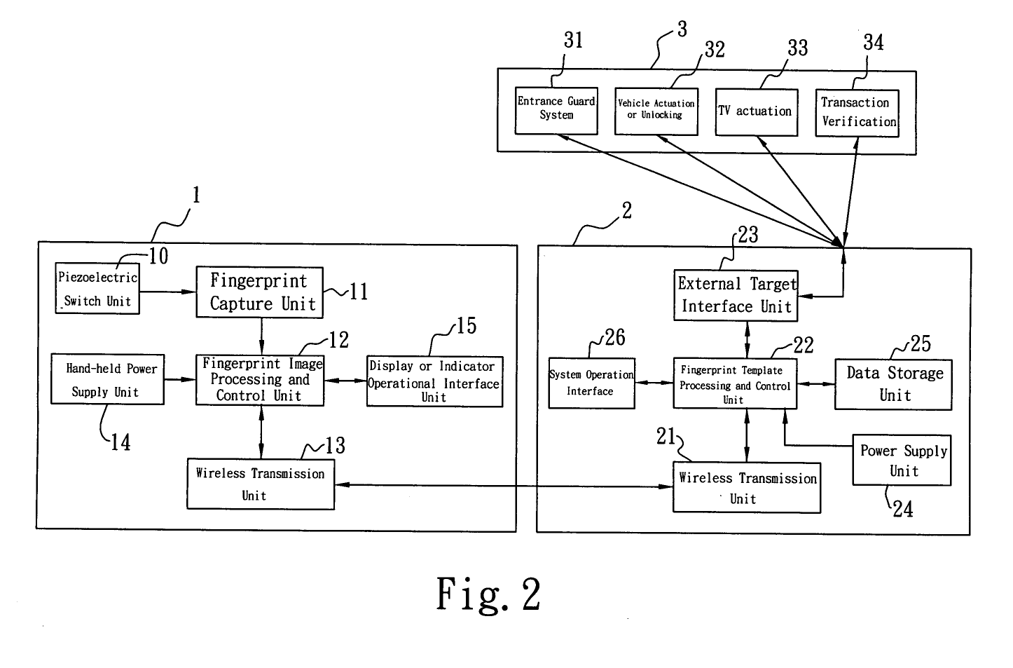

Referring to FIG. 2, the present invention comprises a wireless transmission device 1, a wireless reception device 2 and an external target 3. The wireless transmission device 1 comprises the following functional modules:

a piezoelectric switch unit 10 to supply the wireless transmission device 1 with the electric power when pressed down by the finger or to cut off the power supply when released from the finger so as to save more power than the sleeping mode;

a fingerprint capture unit 11 for capturing the user's fingerprint image by an optical-type, a capacitive-type, an electric filed type, a pressure type, a chip type or other fingerprint capturing method;

a fingerprint image processing and control unit 12 for providing the functions of fingerprint image processing, fingerprint template extraction, and identification;

a wireless transmission unit 13 for receiving the fingerprint data processed by the fingerprint image processing and control unit 12 and transmitting the fingerprint data to a remote site via all kinds of transmission frequencies or wireless transmission/reception technologies, such as a general car-use frequency channel of 433.92 MHz or 315 MHz or a transmission/reception module of Bluetooth wireless communication, 802.11a/b/g, or GSM/GPRS/3G;

a hand-held power supply unit 14, such as a general rechargeable lithium polymer battery, a mercury battery, a solar battery, or other fuel cell, for connection with the fingerprint image processing and control unit 12 and supplying the electric power thereto; and

a display or indicator operational interface unit 15 for connection with the fingerprint image processing and control unit 12 so as to display or show the operation result or the status of the external target 3 such as the vehicle's fuel level and to provide the interface for input operation.

The wireless reception device 2 comprises the following functional modules:

a wireless transmission unit 21 for receiving the data transmitted from the wireless transmission unit 1 via a general car-use frequency channel of 433.92 MHz or 315 MHz or a wireless transmission/reception module of Bluetooth wireless communication, 802.11a/b/g, or GSM/GPRS/3G;

a fingerprint template processing and control unit 22 for providing the functions of fingerprint image processing, fingerprint template extraction, and fingerprint template comparison;

an external target interface unit 23 to act as a control interface between the wireless reception device 2 and the external target 3 so as to control the external target via a signal and to receive a feedback signal from the external target, wherein it can be, for example, applied to the actuation detection of vehicle's engine so as to stop the signal that actuates the motor;

a power supply unit 24, such as a general rechargeable lithium polymer battery, a mercury battery, a solar battery, or other fuel cell, for connection with the fingerprint template processing and control unit 22 and supplying the electric power thereto, wherein the electric power is alternatively supplied by the external target;

a data storage unit 25 for storing a fingerprint minutia and related user data so as to allow the fingerprint template processing and control unit 22 to perform fingerprint comparison; and

a system operation interface 26, which connects with the fingerprint template processing and control unit 22, for managing and registering the related data of user's fingerprint and for setting, updating and maintaining the system by an external setting box, a serial transmission technology or a wireless transmission device.

The external target 3 is, such as an entrance guard system 31, vehicle actuation or unlocking 32, TV actuation 33, or transaction verification 34, and so forth.

By means of constitution of the aforesaid units, the operation process of the present invention is divided into two stages. The first stage is related to data registration and fingerprint enrollment, wherein the user can utilize the embedded special functions of the fingerprint template processing and control unit 22 to activate a native fingerprint enrolling process directly by means of the system operation interface 26 or utilize the external setting box to register the data into the data storage unit 25. Alternatively, the pre-established data may be transmitted to the fingerprint template processing and control unit 22 first and then written into the data storage unit 25 through the system operation interface 26.

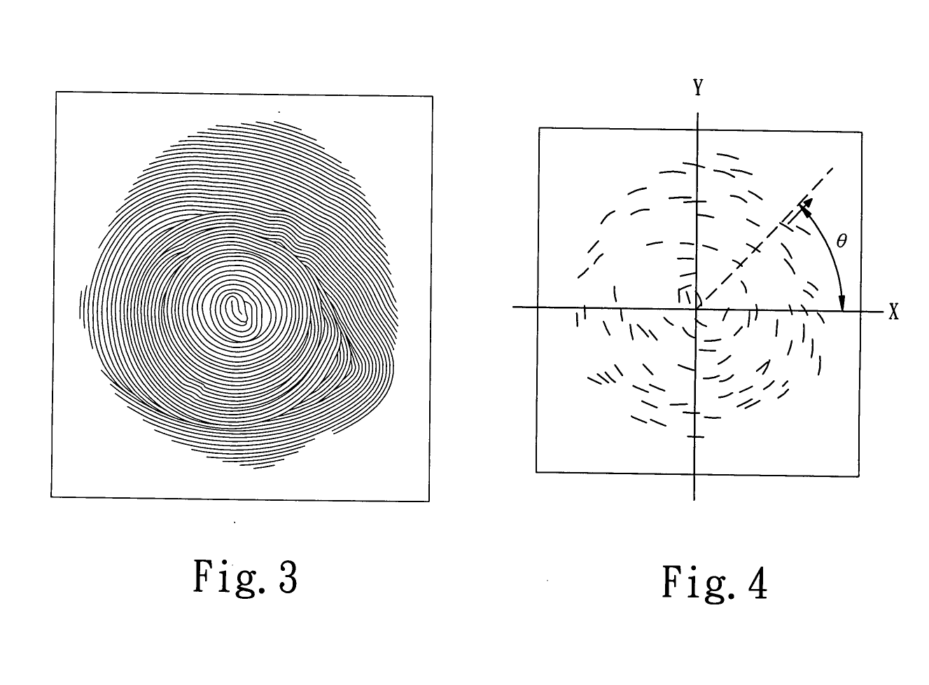

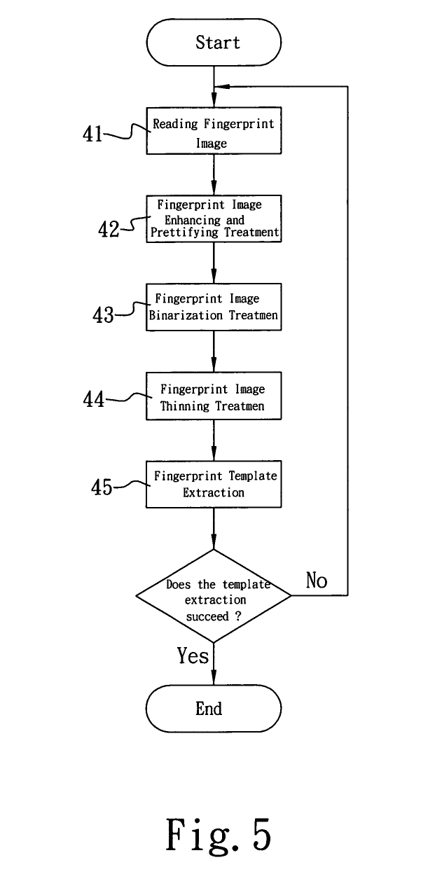

The second stage is related to fingerprint comparison. If the user wants to control the remote external target 3, for example, actuate the vehicle, he/she can make use of the piezoelectric switch unit 10 of the wireless transmission device 1 to input the user's fingerprint image. The piezoelectric switch unit 10 is also a Dual In-line Package (DIP) switch or a micro switch to supply or cut off the electric power when switched on or off, respectively. Referring to FIG. 2, the user's fingerprint image is then captured by the fingerprint capture unit 11, and delivered to the fingerprint image processing and control unit 12. Next, the fingerprint image (shown in FIG. 3) is then transformed into the fingerprint minutia (shown in FIG. 4) by an embedded fingerprint processing algorithm of the fingerprint image processing and control unit 12. Its data structure is indicated by (X, Y, θ), wherein (X, Y) are two-D planar coordinates of the fingerprint minutia, and θ is the direction angle of the fingerprint minutia. Next, this template is encrypted, and packed alone or together with the data inputted via the display or indicator operational interface unit 15 to form a data packet with a packet format compatible with a Self-described Protocol with Variable Length (SPVL) for being delivered to the wireless transmission unit 13. In accordance with the process of fingerprint template extraction, as shown in FIG. 5, a step of reading fingerprint image 41 is performed first. Next, a fingerprint image enhancing and prettifying process 42 is performed. Next, a fingerprint image binarization process 43 and a fingerprint image thinning process 44 are performed in sequence. Finally, a step of fingerprint template extraction 45 is performed. If it is failed to extract the fingerprint template, the fingerprint image is then reread to perform these processes again.

The aforesaid data packet can be transmitted to the wireless transmission unit 21 of the wireless reception device 2 at a remote site via various transmission frequencies or wireless transmission technologies by the wireless transmission unit 13.

The received data packet is then delivered to the fingerprint template processing and control unit 22 by the wireless transmission unit 21 at the remote site. The received data packet is then decoded by the fingerprint template processing and control unit 22 in accordance with the packet format defined by the SPVL protocol. Next, the decoded original template is then matched with the template enrolled in the data storage unit 25 by means of the fingerprint matching algorithm, and the matching result is then delivered to the external target interface unit 23. In addition, the user has option to record or not to record the matching result into the data storage unit 25 by setting the system.

The external target interface unit 23 transforms the matching result into a control signal for controlling the operation of the back-end external target 3, such as vehicle actuation or unlocking, entrance guard system control, TV actuation, or transaction verification, and so forth. In addition, the present invention is further applicable to any car-use remote controller, TV remote controller, entrance guard remote controller, mobile phone, or any remote control system for providing more convenience of use and enhancing security of system.

The back-end external target 3 is also able to transmit the data reversely to the wireless transmission device 1 for offering the function of interactive two-way communication, wherein the data are transmitted from the back-end external target 3 to the external target interface unit 23. Next, the external target interface unit 23 sends out a request or delivers the data reversely to the fingerprint template processing and control unit 22. Next, the fingerprint template processing and control unit 22 packs the data into a data packet with a packet format that is compatible with the Self-described Protocol with Variable Length (SPVL), and it delivers the data packet to the wireless transmission unit 21. Next, the wireless transmission unit 21 transmits the data packet to the wireless transmission unit 13 of the wireless transmission device 1 via various transmission frequencies or wireless transmission technologies. Next, the wireless transmission unit 13 delivers the received data packet to the fingerprint image processing and control unit 12. Next, the fingerprint image processing and control unit 12 decodes the received data packet in accordance with the packet format defined by the SPVL protocol. Next, the decoded data is shown on the hand-held device by the display or indicator operational interface unit 15. Thus, there is provided with the function of interactive two-way communication between the transmission terminal and the reception terminal.

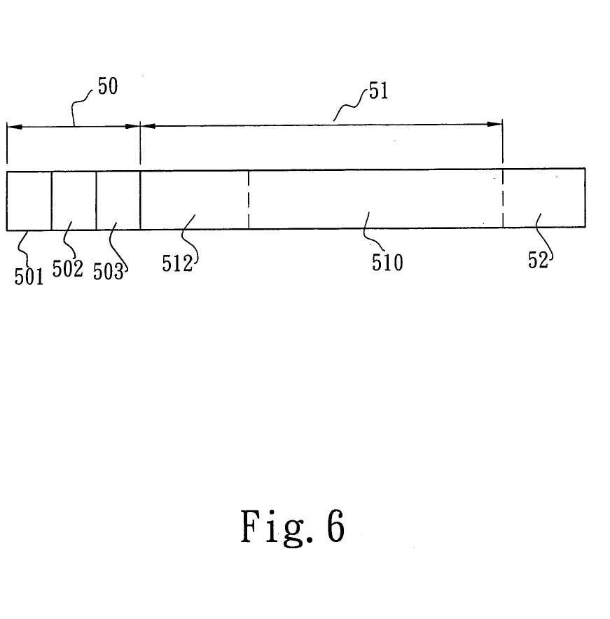

Another characteristic of the present invention is to achieve the flexible, multi-functional application by the use of the Self-described Protocol with Variable Length (SPVL). This communication protocol is able to self-describe various types of data and has variable length. Referring to FIG. 6, the packet format, which is defined by the SPVL protocol, is comprised of a header 50, a data body 51 and a checksum 52. The header 50 comprises: an opcode 501 for representing a remote control operation code; a device ID 502 for representing a hand-held remote control device's identity code; and a data length 503 for representing the length of the data body 51 inside the data packet.

The data body 51 comprises: a data content 510, which is a payload for values of various data types; and a data descriptor 512, which is a data description symbol for describing the data type and the length of the data content 510.

The checksum 52 is an integrity check value of the entire packet.

The data descriptor 512 has the function of self-description with variable length so that it can be changed according to the data characteristic so as to make the packet become small and accelerate the data transmission speed. Besides, there is no need to transmit the packet in sequence such that the flexible, multi-functional application can be achieved and that the information for recording the packet sequence can be thus omitted. When it is applied to the entrance guard remote control, the function of access control, anti-abduction and so forth can be provided through the SPVL protocol definition besides acting as a general remote controller. When it is applied to the TV remote controller, it can be applied for TV channel control or ID reorganization of electronic transaction of TV shopping. When it is applied to the vehicle remote control, other composite function for actuating, such as the engine, the air condition, audio, and so forth, can be provided through the SPVL protocol definition besides providing the general function of unlocking the door.

In summary, the present invention indeed achieves the anticipated objects. Accordingly, the present invention satisfies the requirement for patentability and is therefore submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. An interactive wireless fingerprint recognition system comprising:
a wireless transmission device comprising:
a piezoelectric switch unit to supply said wireless transmission device with the electric power when pressed down by the finger or to cut off the power supply when released from the finger;
a fingerprint capture unit for capturing a fingerprint image of a user;
a fingerprint image processing and control unit for receiving said fingerprint image captured by said fingerprint capture unit, performing a fingerprint template extraction step, performing a packing step to form a data packet with a packet format compatible with a Self-described Protocol with Variable Length (SPVL); and
a wireless transmission unit for receiving said data packet delivered from said fingerprint image processing and control unit and for transmitting said data packet to a remote site;
a wireless reception device comprising:
a wireless transmission unit for receiving said data packet transmitted from said wireless transmission device;
a fingerprint template processing and control unit for receiving and decoding said data packet delivered from said wireless transmission unit to make a comparison with an enrolled fingerprint template;
an external target interface unit to transform a matching result of said fingerprint template processing and control unit into a control signal; and
a data storage unit, which connects to said fingerprint template processing and control unit for storing a fingerprint minutia and related user data; and
an external target for receiving said control signal to perform functional operation and allowing the reception of a feedback signal from said external target, whereby the interactive two-way communication functionality can be achieved, and the security and the convenience of use of said system can be promoted.

2. An interactive wireless fingerprint recognition system of claim 1, wherein said wireless transmission device, said wireless reception device and said external target can be operated in accordance with a reverse process to achieve the function of interactive two-way communication, and said reverse process comprises:
a. said external target transmits data to said external target interface unit;
b. said external target interface unit sends out a request or delivers said data reversely to said fingerprint template processing and control unit;
c. said fingerprint template processing and control unit packs said data into said data packet compatible with said Self-described Protocol with Variable Length (SPVL) and delivers said data packet to said wireless transmission unit of said wireless reception device;
d. said wireless transmission unit of said wireless reception device transmits said data packet to said wireless transmission unit of said wireless transmission device;
e. said wireless transmission unit of said wireless transmission device delivers said data packet to said fingerprint image processing and control unit;
f. said fingerprint image processing and control unit decodes said data packet; and
g. a hand-held device shows a decoding result of said data packet through a display or indicator operational interface unit.

3. An interactive wireless fingerprint recognition system of claim 1, wherein said wireless transmission device further comprises a hand-held power supply unit, which connects with said fingerprint image processing and control unit.

4. An interactive wireless fingerprint recognition system of claim 1, wherein said wireless transmission device further comprises a display or indicator operational interface unit, which connects with said fingerprint image processing and control unit, for display or indication and for input operation.

5. An interactive wireless fingerprint recognition system of claim 1, wherein said wireless reception device further comprises a power supply unit for connection with said fingerprint template processing and control unit.

6. An interactive wireless fingerprint recognition system of claim 1, wherein said wireless reception device further comprises a system operation interface, which connects with said fingerprint template processing and control unit, for managing and registering related data of user's fingerprint and for setting, updating and maintaining said system by an external setting box.

7. An interactive wireless fingerprint recognition system of claim 1, wherein said wireless reception device further comprises a system operation interface, which connects with said fingerprint template processing and control unit, for managing and registering related data of user's fingerprint and for setting, updating and maintaining said system via a serial transmission technology.

8. An interactive wireless fingerprint recognition system of claim 1, wherein said wireless reception device further comprises a system operation interface, which connects with said fingerprint template processing and control unit, for managing and registering related data of user's fingerprint and for setting, updating and maintaining said system via said wireless transmission device.

9. An interactive wireless fingerprint recognition system of claim 1, wherein said fingerprint image processing and control unit transforms said fingerprint image into said fingerprint minutia by a fingerprint processing algorithm that embeds therein, and said fingerprint processing algorithm comprises the steps of: reading said fingerprint image; enhancing and prettifying said fingerprint image; binarizing said fingerprint image; thinning said fingerprint image; and extracting an fingerprint template.

10. An interactive wireless fingerprint recognition system of claim 1, wherein said packet format of said data packet, which is defined by said Self-described Protocol with Variable Length (SPVL), is comprised of a header, a data body and a checksum, wherein said header comprises:
an opcode for representing a remote control operation code; a device ID for representing a hand-held remote control device's identity code; and a data length for representing a length of said data body inside said data packet,
wherein said data body comprises:
a data content, which is a payload for values of various data types;
a data descriptor, which is a data description symbol for describing a data type and a length of said data content and has the function of self-description with variable length, such that the information of said fingerprint template can be recombined by the use of a fingerprint template matching algorithm without the need to transmit said data packet in sequence, whereby the flexible, multi-functional application can be achieved, and
wherein said checksum is an integrity check value of said entire data packet.

11. An interactive wireless fingerprint recognition system of claim 1, wherein said piezoelectric switch unit is a Dual In-line Package (DIP) switch to supply or cut off the electric power when switched on or off, respectively.

12. An interactive wireless fingerprint recognition system of claim 1, wherein said piezoelectric switch unit is a micro switch to supply or cut off the electric power when switched on or off, respectively.
